(19) United States
(12) Patent Application Publication
(10) Pub. No.: US 2013/0246032 A1
(43) Pub. Date: Sep. 19, 2013

(54) Optimal Design System for Development Planning of Hydrocarbon Resources

(71) Applicants: Amr El-Bakry, Houston, TX (US); Robert R. Shuttleworth, Houston, TX (US); Bora Tarhan, Houston, TX (US); Richard T. Mifflin, Houston, TX (US); Shivakumar Kameswaran, Bridgewater, NJ (US)

(72) Inventors: Amr El-Bakry, Houston, TX (US); Robert R. Shuttleworth, Houston, TX (US); Bora Tarhan, Houston, TX (US); Richard T. Mifflin, Houston, TX (US); Shivakumar Kameswaran, Bridgewater, NJ (US)

(21) Appl. No.: 13/988,965

(22) PCT Filed: Dec. 8, 2011
(86) PCT No.: PCT/US2011/063957

§ 371 Date: May 22, 2013

Related U.S. Application Data
(60) Provisional application No. 61/421,438, filed on Dec. 9, 2010.

(30) Foreign Application Priority Data
Sep. 28, 2011 (US) PCT US2011 053703

(51) Int. Cl. G06F 17/50

(52) U.S. Cl. CPC G06F 17/5009
USPC 703/10; 703/9

(57) ABSTRACT

Methods and systems are provided for generating a development plan for a hydrocarbon asset. A high-fidelity computer model of a hydrocarbon asset is created. A low-fidelity computer model of the hydrocarbon asset is created. The low-fidelity computer model is iterated on to an interim solution. A comparison is generated of the interim solution to a solution obtained from a simulation of the high-fidelity computer model at the variables of the interim solution. The low-fidelity computer model is calibrated based, at least in part, on the comparison. The development plan for the hydrocarbon asset is generated based, at least in part, on a result from the calibrated low-fidelity computer model. The low-fidelity computer model is a mixed-integer nonlinear programming problem with complementarity.

### CROSS-REFERENCE TO RELATED APPLICATIONS

This application claims the benefit of U.S. Provisional Patent Application 61/421,438 filed Dec. 9, 2010 entitled OPTIMAL DESIGN SYSTEM FOR DEVELOPMENT PLANNING OF HYDROCARBON RESOURCES, and to International Application No. PCT/US2011/053703 filed Sep. 28, 2011 entitled OPTIMAL DESIGN SYSTEM FOR DEVELOPMENT PLANNING OF HYDROCARBON RESOURCES. These applications are incorporated by reference herein in their entirety for all purposes.

### FIELD

Embodiments of the present techniques relate to a method and system for control of assets. Specifically, an embodiment provides a surrogate or reduced order model based system for obtaining information about the assets.

### BACKGROUND

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

A hydrocarbon asset consists of all aspects and units needed to develop and produce a subsurface accumulation of hydrocarbons. In general, a hydrocarbon asset includes a number of subsurface production units. A production unit is an underground storage unit containing a certain amount of hydrocarbons. Such units may include a reservoir, a compartment, a region, or a field. The hydrocarbon resource system may also include a production system, a number of wells of different types and locations, and a number of surface facilities, such as floating production, storage and offloading (FPSO) platforms, tension leg platforms (TLPs), hydrocarbon/water separation facilities, compressors, and the like.

The development of a hydrocarbon resource can involve high-value, high-cost decisions that may be in the billions of dollars. The process of making the capital investment decisions associated with the initial development of hydrocarbon resources or facility expansion of a hydrocarbon resource is known as development planning. The process of making operational strategies such as the injection scheme, the allocation of production rates across wells, working over wells, and drilling new wells for a hydrocarbon resource is known as reservoir management.

In general, a development plan includes a set of strategic and tactical decisions for optimal use of resources to achieve the goals and objectives of the resource management team, such as maximizing net present value or the rate of return, among others. In the oil and gas industry, the strategic decisions include, among others, the selection of type and size of facilities, the locations, and number of wells, the scheduling of installation and production of facilities and wells, and other interactions, including marketing options, and facility-to-facility and well-to-facility connections. Examples of markets include power plants, refineries, and LNG trains. Tactical decisions can include facility expansions, production drive mechanisms, timing of facility and reservoir compartment startups, and injection and production rates, among others.

Development planning generally involves selecting an optimal decision from a set of potential candidates for each decision. Reservoir management involves selecting an optimal injection/production scheme from a set of potential candidates for each decision. For both strategies, the candidates generally satisfy a set of constraints as formulated by the asset development team, including, for example, physical, environmental, contractual, political, or financial constraints, among others. The selection process chooses the candidate that optimizes criteria related to project goals and objectives.

In general, optimization is the problem of maximizing or minimizing some objective function with respect to a set of constraints. For a continuous problem with controls, the optimization process may be performed by taking the derivative or some approximation to the derivative of the governing equations with respect to the control variables. However the computational cost of a high-fidelity computer model of a reservoir simulation, for example, at each of the iterations, can be problematic due to the size of realistic problems and the number of optimization variables at each point. Accordingly, a number of simplifications may be used to make the optimization of a high-fidelity reservoir model more feasible.

As an example, another way to optimize a problem is by using mathematical programming. A mathematical optimization problem involves the optimization of some objective function, subject to a set of constraints on the problem variables. In the scientific and engineering community, some of the subcategories of mathematical programming include linear programming (LP), mixed integer programming (MIP), nonlinear programming (NLP), and mixed-integer nonlinear programming (MINLP). A typical deterministic optimization model contains an objective function, f, that is optimized subject to an array of constraint functions, g and h, which can be satisfied by setting the values of decision variable arrays x and y. The constraint functions generally include a combination of known data parameters and unknown variable values when a programming model is posed. An optimization model is usually written as shown in the formulas in Eqn. 1.

min f(x,y)

g(x,y)≦0

h(x,y)=0

s.t. xε[Lₓ,Uₓ]

yεI Eqn. 1

In Eqn. 1, Lₓ, U_{y} are upper and lower bounds on the variables x and I is a set of discrete values that y may assume. There has been significant research in the area of model reduction and development planning optimization.

U.S. Pat. No. 7,478,024 to Gurpinar, et al., discloses an “integrated reservoir optimization.” The method includes generating an initial reservoir characterization, and from the initial reservoir characterization, generating an initial reservoir development plan. A capital spending program may be incrementally advanced and generated. Performance of the reservoir may be monitored by acquiring high rate monitor data from a first set of data measurements taken in the reservoir and using the high rate monitor data to perform well-regional and field-reservoir evaluations. Further monitoring of the performance of the reservoir is performed by acquiring low rate monitor data from a second set of data measurements taken in the reservoir. The high rate monitor data and the low rate monitor data are assimilated together, and a determination is made as to when it is necessary to update the initial reservoir development plan to produce a newly updated reservoir development plan. When necessary, updating the initial reservoir development plan to produce the newly updated reservoir development plan is performed by repeating the procedure above.

International Patent Publication Nos. WO/2009/131761, WO/2009/128972, and WO/2009/145960, by Goel and Furman, disclose stochastic decision support tools for reservoir development planning. The tools can include a source of input data, an optimization model, a high fidelity computer model for simulating the reservoir, and one or more solution routines interfacing with the optimization model. The optimization model can consider unknown parameters having uncertainties directly within the optimization model. The model incorporates the flexibility that a decision-maker has in the real world and allows the decision-maker to adjust the decisions based on new information. The model can systematically address uncertain data, for example comprehensively or even taking all uncertain data into account. Accordingly, the optimization model can provide flexible or robust solutions that remain feasible over an uncertainty space. Once the reservoir model is optimized, final development plans may be generated.

However, these three applications do not disclose an iterative process to create and manage surrogates, for example, using consistency conditions to ensure compatibility. Moreover, the techniques disclosed are directed to situations in which the variables in the optimization process are uncertain, not deterministic.

Further references include Brouwer, D. R. and Jansen, J. D., “Dynamic Optimization of Water Flooding with Smart Wells using Optimal Control Theory,” SPE 78278, SPE Journal, December 2004, pp. 391-402 (Society of Petroleum Engineers), which discloses the use of optimal control theory as an optimization algorithm for the valves settings in smart wells. Specifically, the reference focuses on the use in injectors and producers for the waterflooding of heterogeneous reservoirs. A systematic dynamic optimization approach based on optimal control theory is developed. The objective is to maximize recovery or net present value of the waterflooding process over a given time period.

Kraaijevanger, J., Egberts, P., Valstar, J., and Buurman, H., “Optimal Waterflood Design Using the Adjoint Method,” SPE 105764 (Society of Petroleum Engineers, 2007), addresses the problem of how to operate the injectors and producers of an oil field so as to maximize the value of the field. Instead of aggressively producing and injecting fluids at maximum rate aiming at short term profits, the authors target optimizing the total value, for example, the discounted oil volume, over the whole lifecycle of the field. An adjoint method from optimal control theory is used to solve the optimization problem.

Quesada, I. and I.E. Grossmann, “An LP/NLP Based Branch and Bound Algorithm for MINLP Optimization,” Computers and Chemical Engineering, 16, 937 (1992), disclose a technique for improving the solution efficiency of convex mixed integer non-linear programming (MINLP) problems. In the technique, a mixed integer linear programming (MILP) master problem is not explicitly solved at each iteration. Instead, the MILP master problem is dynamically defined during the tree search, which reduces the number of nodes for enumeration. A branch and bound search is conducted to predict lower bounds by solving linear programming (LP) subproblems, and find feasible integer solutions for nodes. At nodes having feasible integer solutions, nonlinear programming subproblems are solved, providing upper bounds and new linear approximations, which are used to tighten the linear representation of the open nodes in the search tree. New types of linear approximations are proposed to reduce the size of the LP subproblems. These linear approximations exploit linear substructures in the MINLP problem.

Sarma, P., Aziz, K. and Durlofsky, L. J., “Implementation of Adjoint Solution for Optimal Control of Smart Wells,” SPE 92864 (Society of Petroleum Engineers, 2004), discloses another method for solving optimization problems in reservoir models using optimal control theory. The authors use the underlying simulator as the forward model, and the adjoint for the calculation of gradients. The adjoint procedure is simplified by calculating and storing all information necessary for the adjoint run during the forward run of a fully implicit forward model and specific forms of the cost function and nonlinear constraints. As a result, the adjoint code is essentially independent of the forward model, which leads to enhanced efficiency as no calculations are repeated.

Sarma, P., Chen, W., Durlofsky, L. J. and Aziz, K. “Production Optimization with Adjoint Models under Nonlinear Control-State Path Inequality Constraints”, SPE 99959 (Society of Petroleum Engineers, 2006), discloses yet another technique for solving optimization problems in the simulations of petroleum production. The authors describe an approximate feasible direction nonlinear programming problem (NLP) algorithm based on the objective function gradient and a combined gradient of the active constraints. The approximate feasible direction is converted into a true feasible direction by projecting it onto the active constraints by solving the constraints during the forward model evaluation.

The four works listed above describe an adjoint-based optimization on a single high-fidelity reservoir model only. However, the papers do not disclose an iterative process to create or manage surrogates.

### SUMMARY

An embodiment provides a method for generating a development plan for a hydrocarbon asset. The method includes creating a high-fidelity computer model of a hydrocarbon asset and a low-fidelity computer model of the hydrocarbon asset. The low-fidelity computer model may be iterated on to reach an interim solution. A comparison of the interim solution may be generated to a solution obtained from a simulation of the high-fidelity computer model at the variables of the interim solution. The low-fidelity computer model can be calibrated, based, at least in part, on the comparison. The development plan for the hydrocarbon asset may be generated based, at least in part, on a result from the calibrated low-fidelity computer model. The low-fidelity computer model is a mixed-integer nonlinear programming problem with complementarity.

The high-fidelity computer model may also be adjusted based, at least in part, on the comparison. Creating the high-fidelity computer model may include creating a reservoir simulation for a hydrocarbon bearing compartment.

Calibrating the low-fidelity computer model may include adjusting the low-fidelity computer model to provide a matching result to the high-fidelity computer model at a point in a low-fidelity solution space that corresponds to a point in a high-fidelity solution space. Further, calibrating the low-fidelity computer model may also include adjusting the low-fidelity computer model to provide a matching first-derivative to the high-fidelity computer model at a point in a low-fidelity solution space that corresponds to a point in a high-fidelity solution space. The interim solution may be mapped to the high-fidelity space.

The low-fidelity computer model may be constrained, based, at least in part, on the comparison. The high-fidelity computer model may be optimized in part. The low-fidelity computer model may be created by using fewer degrees of freedom than the high-fidelity computer model. A graphical representation of the development plan may be generated during or after an optimization process.

A mixed-integer nonlinear programming problem (MINLP) model may be created as the low-fidelity computer model. The MINLP model may be solved using a branch-and-bound technique. A linear relaxation model may be created for the MINLP model. The linear relaxation model may be optimized and the linear relaxations iteratively tightened. Feasible solutions for the MINLP model may be generated from the feasible solutions found for the linear relaxation model. The linear relaxation model may include a mixed integer linear program (MILP).

Another embodiment provides a system for generating a development plan for a hydrocarbon asset. The system may include a processor, and a non-transitory, computer readable medium. The non-transitory, computer readable medium may include a high-fidelity computer model of a hydrocarbon asset. The non-transitory, computer readable medium may also include code configured to direct the processor to: create a low-fidelity computer model of the hydrocarbon asset from the high-fidelity computer model, the low-fidelity computer model being a mixed-integer nonlinear programming problem with complementarity; iterate the low-fidelity computer model to an interim solution; compare the interim solution to a solution obtained from a run of the high-fidelity computer model at the parameters of the interim solution; calibrate the low-fidelity computer model, based, at least in part, on the comparison; and provide a development plan based, at least in part, on a calibrated low-fidelity computer model.

The non-transitory, computer readable medium may also include code configured to direct the processor to adjust the high-fidelity computer model based, at least in part, on a result from the calibrated low-fidelity computer model. The system may include a cluster computing system.

The non-transitory, computer readable medium may also include code configured to direct the processor to create a strategic model, a tactical model, or any combinations thereof. The low-fidelity computer model or the high-fidelity computer model, or both, may include a strategic model. The low-fidelity computer model or the high-fidelity computer model, or both, may include a tactical model. The low-fidelity computer model or the high-fidelity computer model, or both, may include an economic model of the hydrocarbon asset.

The development plan may include a tactical decision, which may include, for example, an injection flow rate, a production rate, a timing for a compartment, or any combinations thereof. The development plan may include a strategic decision, which may include, for example, a well location, a number of production platforms, a type of a production platform, or any combinations thereof. Diagnostic tests may be used to enhance a performance of the system. The low fidelity computer model can be generated from the high fidelity computer model using an optimization framework to ensure consistency.

Another embodiment provides a non-transitory computer readable medium that includes code configured to direct a processor to: iterate a low-fidelity computer model to an interim solution and compare the interim solution to a solution obtained from a run of a high-fidelity computer model at the parameters of the interim solution. The low-fidelity computer model is a mixed-integer nonlinear programming problem with complementarity. The non-transitory, computer readable medium may also include code configured to calibrate the low-fidelity computer model, based, at least in part, on the comparison, and generate a development plan for a hydrocarbon asset, based, at least in part, on a result from a calibrated low-fidelity computer model.

### DESCRIPTION OF THE DRAWINGS

The advantages of the present techniques are better understood by referring to the following detailed description and the attached drawings, in which:

FIG. 1 is a drawing of an exemplary hydrocarbon asset that may be developed in accordance with an embodiment;

FIG. 2 is a drawing of a multi-level reservoir simulation at decreasing levels of fidelity, in accordance with some embodiments;

FIG. 3 is a block diagram of a process model that may be used in an embodiment;

FIG. 4 is a block diagram illustrating a method for implementing a surrogate management loop, in accordance with an embodiment;

FIG. 5 is a block diagram illustrating a method for implementing a surrogate management loop in which the design space provides the complexity, in accordance with an embodiment;

FIG. 6 is a process flow diagram of a method for solving a mixed integer nonlinear programming (MINLP) model in accordance with an embodiment;

FIG. 7 is a drawing of a procedure that may be used to create a branch in the method used in FIG. 6, in accordance with an embodiment;

FIG. 8 is a block diagram of a method that may be used in embodiments;

FIG. 9 is a drawing of a procedure that may be used to create a branch in the method discussed with respect to FIG. 8, in accordance with an embodiment;

FIG. 10 is a block diagram of a general method encompassing the methods discussed with respect to FIGS. 4 and 5, in accordance with embodiments; and

FIG. 11 is a block diagram of an exemplary cluster computing system that may be used in exemplary embodiments of the present techniques.

### DETAILED DESCRIPTION

In the following detailed description section, the specific embodiments of the present techniques are described in connection with embodiments. However, to the extent that the following description is specific to a particular embodiment or a particular use of the present techniques, this is intended to be for exemplary purposes only and simply provides a description of the embodiments. Accordingly, the present techniques are not limited to the specific embodiments described below, but rather, such techniques include all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

The terms “Crude oil” or “hydrocarbon oil” denote a carbonaceous liquid that is harvested from a reservoir. Crude oil has a wide boiling ranges and sulfur content in different fractions.

As used herein, “displaying” or “to display” includes a direct act that causes displaying of a graphical representation of a physical object, as well as any indirect act that facilitates displaying a graphical representation of a physical object. Indirect acts include providing a website through which a user is enabled to affect a display, hyperlinking to such a website, or cooperating or partnering with an entity who performs such direct or indirect acts. The display device may include any device suitable for displaying the reference image, such as without limitation a virtual reality display, a 3-D display, a CRT monitor, a LCD monitor, a plasma device, a flat panel device, or printer.

“Exemplary” is used exclusively herein to mean “serving as an example, instance, or illustration.” Any embodiment described herein as exemplary is not to be construed as preferred or advantageous over other embodiments.

A “facility” is tangible piece of physical equipment, or group of equipment units, through which hydrocarbon fluids are either produced from a reservoir or injected into a reservoir. In its broadest sense, the term facility is applied to any equipment that may be present along the flow path between a reservoir and its delivery outlets, which are the locations at which hydrocarbon fluids either leave the model (produced fluids) or enter the model (injected fluids). Facilities may comprise production wells, injection wells, well tubulars, wellhead equipment, gathering lines, manifolds, pumps, compressors, separators, surface flow lines, and delivery outlets. In some instances, the term “surface facility” is used to distinguish those facilities other than wells.

“Formation” refers to a body of rock or other subsurface solids that is sufficiently distinctive and continuous that it can be mapped, for example, by seismic techniques. A formation can be a body of rock of predominantly one type or a combination of types. A formation can contain one or more hydrocarbon-bearing zones. Note that the terms formation, hydrocarbon reservoir, and interval may be used interchangeably, but will generally be used to denote progressively smaller subsurface regions, zones, or volumes. More specifically, a formation will generally be the largest subsurface region, a hydrocarbon reservoir will generally be a region within the formation and will generally be a hydrocarbon-bearing zone (a formation, reservoir, or interval having oil, gas, heavy oil, and any combination thereof), and an interval will generally refer to a sub-region or portion of a reservoir. A hydrocarbon-bearing zone can be separated from other hydrocarbon-bearing zones by zones of lower permeability such as mudstones, shales, or shale-like (highly compacted) sands. In one or more embodiments, a hydrocarbon-bearing zone includes heavy oil in addition to sand, clay, or other porous solids.

“Hydrocarbon production” refers to any activity associated with extracting hydrocarbons from a well or other opening. Hydrocarbon production normally refers to any activity conducted in or on the well after the well is completed. Accordingly, hydrocarbon production or extraction includes not only primary hydrocarbon extraction but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

“Hydrocarbons” are generally defined as molecules formed primarily of carbon and hydrogen atoms such as oil and natural gas. Hydrocarbons may also include other elements, such as, but not limited to, halogens, metallic elements, nitrogen, oxygen, and/or sulfur. Hydrocarbons may be produced from hydrocarbon reservoirs through wells penetrating a hydrocarbon containing formation. Hydrocarbons derived from a hydrocarbon reservoir may include, but are not limited to, kerogen, bitumen, pyrobitumen, asphaltenes, oils, natural gas, or combinations thereof. Hydrocarbons may be located within or adjacent to mineral matrices within the earth, termed reservoirs. Matrices may include, but are not limited to, sedimentary rock, sands, silicilytes, carbonates, diatomites, and other porous media.

As used herein, “material properties” represents any number of physical constants that reflect the behavior of a rock. Such material properties may include, for example, Young's modulus (E), Poisson's Ratio (□), tensile strength, compressive strength, shear strength, creep behavior, and other properties. The material properties may be measured by any combinations of tests, including, among others, a “Standard Test Method for Unconfined Compressive Strength of Intact Rock Core Specimens,” ASTM D 2938-95; a “Standard Test Method for Splitting Tensile Strength of Intact Rock Core Specimens [Brazilian Method],” ASTM D 3967-95a Reapproved 1992; a “Standard Test Method for Determination of the Point Load Strength Index of Rock,” ASTM D 5731-95; “Standard Practices for Preparing Rock Core Specimens and Determining Dimensional and Shape Tolerances,” ASTM D 4435-01; “Standard Test Method for Elastic Moduli of Intact Rock Core Specimens in Uniaxial Compression,” ASTM D 3148-02; “Standard Test Method for Triaxial Compressive Strength of Undrained Rock Core Specimens Without Pore Pressure Measurements,” ASTM D 2664-04; “Standard Test Method for Creep of Cylindrical Soft Rock Specimens in Uniaxial Compressions,” ASTM D 4405-84, Reapproved 1989; “Standard Test Method for Performing Laboratory Direct Shear Strength Tests of Rock Specimens Under Constant Normal Stress,” ASTM D 5607-95; “Method of Test for Direct Shear Strength of Rock Core Specimen,” U.S. Military Rock Testing Handbook, RTH-203-80, available at “http://www.wes.army.mil/SL/MTC/handbook/RT/RTH/203-80.pdf” (last accessed on Jun. 25, 2010); and “Standard Method of Test for Multistage Triaxial Strength of Undrained Rock Core Specimens Without Pore Pressure Measurements,” U.S. Military Rock Testing Handbook, available at http://www.wes.army.mil/SL/MTC/handbook/RT/RTH/204-80.pdf” (last accessed on Jun. 25, 2010). One of ordinary skill will recognize that other methods of testing rock specimens may be used to determine the physical constants used herein.

“Natural gas” refers to various compositions of raw or treated hydrocarbon gases. Raw natural gas is primarily comprised of light hydrocarbons such as methane, ethane, propane, butanes, pentanes, hexanes and impurities like benzene, but may also contain small amounts of non-hydrocarbon impurities, such as nitrogen, hydrogen sulfide, carbon dioxide, and traces of helium, carbonyl sulfide, various mercaptans, or water. Treated natural gas is primarily comprised of methane and ethane, but may also contain small percentages of heavier hydrocarbons, such as propane, butanes, and pentanes, as well as small percentages of nitrogen and carbon dioxide.

“Non-transitory, computer-readable medium” refers to any tangible storage medium that participates in providing instructions to a processor for execution. Such a medium may include, but is not limited to, non-volatile media and volatile media. Non-volatile media includes, for example, NVRAM, magnetic disks, or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like.

“Pressure” refers to a force acting on a unit area. Pressure is usually shown as pounds per square inch (psi). “Atmospheric pressure” refers to the local pressure of the air. Local atmospheric pressure is assumed to be 14.7 psia, the standard atmospheric pressure at sea level. “Absolute pressure” (psia) refers to the sum of the atmospheric pressure plus the gauge pressure (psig). “Gauge pressure” (psig) refers to the pressure measured by a gauge, which indicates only the pressure exceeding the local atmospheric pressure (a gauge pressure of 0 psig corresponds to an absolute pressure of 14.7 psia).

As previously mentioned, a “reservoir” or “hydrocarbon reservoir” is defined as a pay zone (for example, hydrocarbon-producing zones) that includes sandstone, limestone, chalk, coal, and some types of shale. Pay zones can vary in thickness from less than one foot (0.3048 m) to hundreds of feet (hundreds of m). The permeability of the reservoir formation provides the potential for production.

“Reservoir properties” and “Reservoir property values” are defined as quantities representing physical attributes of rocks containing reservoir fluids. The term “reservoir properties” as used in this application includes both measurable and descriptive attributes. Examples of measurable reservoir property values include impedance to P-waves, impedance to S-waves, porosity, permeability, water saturation, and fracture density. Examples of descriptive reservoir property values include facies, lithology (for example, sandstone or carbonate), and environment-of-deposition (EOD). Reservoir properties may be populated into a reservoir framework of computational cells to generate a reservoir or rock physics model.

“Reservoir simulation” refers to a specific mathematical calculation concerning a real hydrocarbon reservoir. Reservoir simulations conduct numerical experiments on rock physics models regarding past performance. These numerical experiments may be used to verify that an understanding of the reservoir properties is correct. Further, the numerical experiments may be used to predict the future performance of a field with the goal of determining the most profitable operating strategy. An engineer managing a hydrocarbon reservoir may run many different reservoir simulations, possibly with varying degrees of complexity.

A “rock physics model” or “reservoir model” may be used by a reservoir simulator to relate petrophysical and production-related properties of a rock formation (or its constituents) to the bulk elastic properties of the rock formation. Examples of petrophysical and production-related properties may include, but are not limited to, porosity, pore geometry, pore connectivity volume of shale or clay, estimated overburden stress or related data, pore pressure, fluid type and content, clay content, mineralogy, temperature, and anisotropy and examples of bulk elastic properties may include, but are not limited to, P-impedance and S-impedance.

### Overview

In determining the decisions used to develop a field, e.g., generating a development plan, the behavior of various constraints, such as economic terms, contractual obligations, geologic models, reservoir models, and facilities, among others, can be very complex, and may provide a significant challenge for a development planner. Embodiments described herein integrate the development planning constraints into a model formulation, algorithmic approach, and business process to solve this problem. The development planning and expansion problem is modeled through an iterative process that integrates multiple, varying fidelity computer models, or surrogates, of the hydrocarbon resource environment and its constraints, using optimization technology to meet the objectives of the decision-makers. The iterative process can improve the design or plan until a certain objective posed by the decision-maker is reached.

The iterative approach may improve the efficiency in using computational resources to find a solution. Typically, higher-fidelity computer models execute more slowly, in terms of computational time, when compared to lower fidelity computer models. Embodiments provide a process to manage the complexity and cost of running the high-fidelity computer model and computing derivatives by iterating between multiple-fidelity computer models to find successively better solutions to the high-fidelity, or reference, model.

The iterative process may provide a flexible framework for decomposing the design system into more easily handled sub-levels. It may also provide a robust mechanism for integrating the sub-levels in order to provide a solution to the overall design problem. Further, the process provides flexibility in using different resolution for the same variables in different sub-levels and then mapping them back to the reference model representation.

For example, an embodiment may use a mixed-integer nonlinear programming (MINLP) model as a low-fidelity computer model and a detailed reservoir simulation model as a high-fidelity computer model. Some embodiments may use consistency conditions to help in ensuring directional compatibility of different fidelity computer models in development planning. A set of feasible solutions, as opposed to a ‘single’ optimal solution, may be passed to the high-fidelity computer model.

The decision space may be decomposed into smaller spaces and multi-level optimization technology may be used to construct potential solutions of the original problem. An example is to use a low-fidelity computer model, such as the mixed-integer nonlinear program (MINLP) model, for strategic decisions, and a high-fidelity computer model, such as a reservoir simulation, for tactical decisions. As used herein, a strategic decision can be a decision concerning resource allocation, such as well placement, facility placement, number of wells, interconnections between wells and facilities, and the like. A tactical decision can be a decision made in relation to a time related data stream, such as an injection rate, a production rate, when a compartment begins production, and the like. In various embodiments, the methods described herein integrate time-dependent data, such as well-rates, or past production data, with strategic decisions, such as well placement and number, to optimize hydrocarbon recovery decisions. Accordingly, the techniques described herein can generate an optimized development plan.

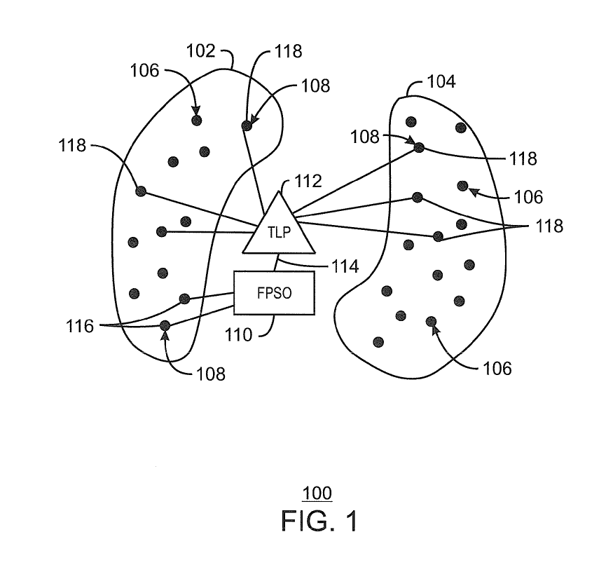

FIG. 1 is a drawing of an exemplary hydrocarbon asset 100 that may be developed in accordance with an embodiment. The asset consists of two reservoirs 102 and 104, each reservoir having a number of potential wells 106 that can be drilled and produced during the planning horizon. Further, each reservoir 102 and 104 may have a number of active wells 108, either injectors or producers, and may be coupled to facilities at the surface of the ocean or land. The surface production facilities may include, for example, a Floating Production Storage and Offloading (FPSO) vessel 110, a Tension Leg Platform (TLP) 112, or any number of other platforms or surface facilities used to harvest hydrocarbons from land or subsea reservoirs. The number, type, and size of the surface facilities 110 and 112 are design decisions made during the development planning process. The size of the surface facilities 110 and 112 may be modeled as a continuous variable or as a discrete variable, e.g., restricting the facility to a set of pre-defined sizes. FPSO 110 and TLP 112 facilities provide different capabilities in drilling active wells 108, and processing hydrocarbons, and they also have different associated capital construction costs and lead time between the construction decision and the start of production.

The FPSO 110 and TLP 112 facilities can be connected to each other through risers 114. Accordingly, hydrocarbons recovered from a TLP facility 112 can be pumped to a FPSO facility 110 through the risers 114. For clarity of explanation, this example is simplified. However, it will be clear that the techniques are not limited to this embodiment, as any number, types, or combinations of assets may be developed or optimized.

The problem to be considered is the design and planning of an oil field development over a specified planning horizon. Such fields may include offshore fields, and land based fields, among others. The system under consideration can be a two-phase system, for example, including oil and water. The system may also be a three-phase system that includes oil, water, and gas. Other design decisions include well type and well-to-facility connections, e.g., which active wells 108 are connected to which facilities 110 or 112.

An active well 108 can be either a sub-sea well 116 or a TLP well 118. Drilling ships are used to drill sub-sea wells 116, so there is no need to have a facility present to drill the subsea well 116. Unlike sub-sea wells 116, a TLP well 118 is drilled from a TLP facility 112. For economic reasons, a fixed number of active wells 108 of each type 116 and 118 are drilled consecutively. An active well 108 can be connected to a facility 110 or 112 to recover the hydrocarbon. A sub-sea well 116 is connected to an FPSO facility 110, while a TLP well 108 is connected to a TLP facility 112.

Investment and operational decisions are made over the planning horizon to maximize goals, such as income or total recovery. Investment or strategic decisions include the number, type, and capacity of facilities 110 and 112 (among others) along with an installation schedule of these facilities, the types of wells (injectors, producers, FPSO wells 116, or TLP wells 118, among others), and the well drilling schedule. Operation or tactical decisions include the amount of oil produced for each time period given the reservoirs' sizes.

For the reference reservoir model, a three-phase (oil, water, and gas) reservoir simulation with rock and fluid properties may be useful. Since it may be assumed that there is no communication between reservoirs, each reservoir can be modeled separately and only coupled to other reservoirs through the surface facilities 110 and 112. Given the number, types, and capacities of surface facilities 110 and 112 (among others), we may optimize the drilling plan (including the number, type and schedule of wells to be drilled) to maximize hydrocarbon production rates over the planning horizon, which is generally about 10-15 years.

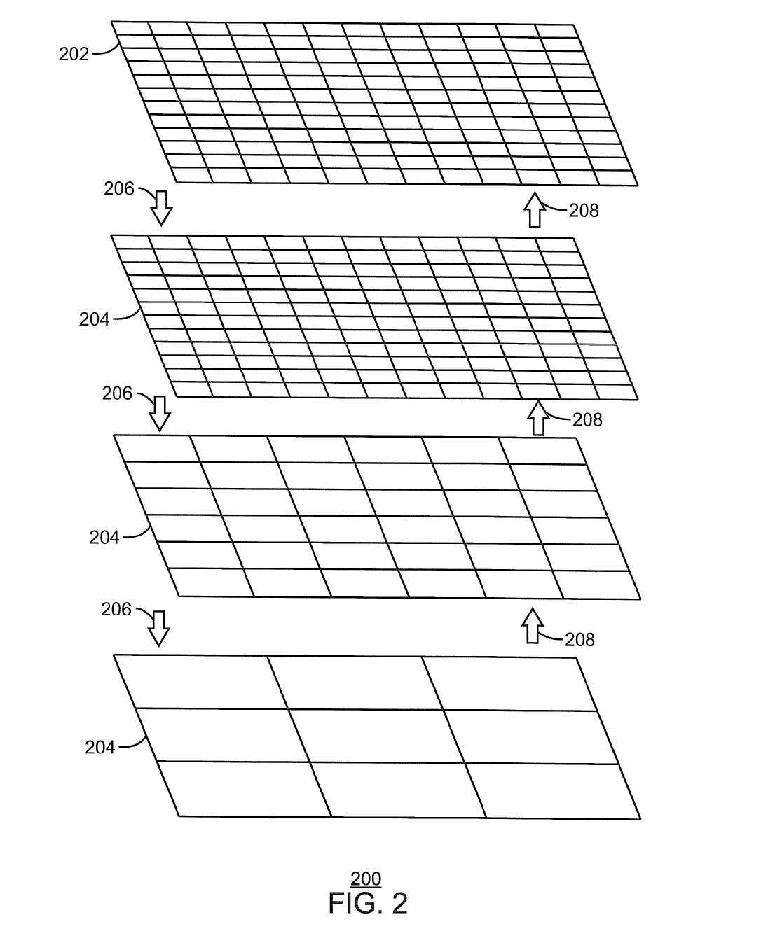

FIG. 2 is a drawing of a multi-level reservoir simulation 200 at decreasing levels of fidelity, in accordance with some embodiments. A high-fidelity or reference reservoir model defined on a structured or unstructured grid 202 can be used for each compartment of the reservoir. As used herein, a compartment or hydrocarbon-bearing compartment is an isolated production zone in the reservoir that is not in fluid communication with any other production zone in the reservoir. The high-fidelity computer model may be a full physics model, such as a multi-phase and multi-component that describes the fluid flow behavior in the compartment.

One or more low-fidelity computer models 204 can be created, for example, by using piecewise linear functions that represent estimated ultimate recovery from each compartment. Average flow rates on an annual basis can be mapped from the high-fidelity computer model 202 to the lower-fidelity computer models 204, as indicated by an arrow 206. A lower-fidelity computer model 204 can be passed to an optimizer, which solves the low-fidelity computer model 204, for example, using a nonlinear branch and bound technique. The solution of the low-fidelity computer model 204 can then be mapped back to the high-fidelity computer model 202 to check the solution and evaluate the objective function, as indicated by an arrow 208. This iterative process may continue until the oil production rate from the models 202 and 204 is maximized. The hierarchical series of models form a surrogate management loop that may be used to effectively model the process.

As used herein, a surrogate management loop (SML) is an iterative business process that alternates between multiple levels of variable-fidelity optimization problems. One level may be considered a “true” or reference optimization model. For example, in the multi-level reservoir simulation 200, the high-fidelity computer model 202 provides the most detailed or accurate results and can be considered the reference model. The reference model may capture the optimization requirements in detail, as well as capturing the information known about the system. The SML iterative process is designed to assist in the convergence to the solution of the high-fidelity or reference model through use of the lower fidelity optimization models. This may lower the computational costs substantially. In the following description, a two-level surrogate management loop is used to simplify the explanation.

The design of an optimal development plan for hydrocarbon assets requires handling complexity in both asset modeling, e.g., in a reservoir simulation, where complexity may be reflected in the cost of running a model, and in design space, where complexity may be reflected in the number of design decisions. An embodiment may reduce the computational complexity of modeling the development planning design process by implementing the multi-level process in an SML using interacting optimization models. Thus, the complexity in the underlying asset models or design space can be distributed among the levels in such a way that each level can contribute to the overall optimal design without providing more complexity or adding more computational costs, than needed. There are many variations of how this process can be designed or structured. For example, in some embodiments asset modeling complexity in the form of a simulation may be the main source of complexity, while in some embodiments the design space is the main source of complexity.

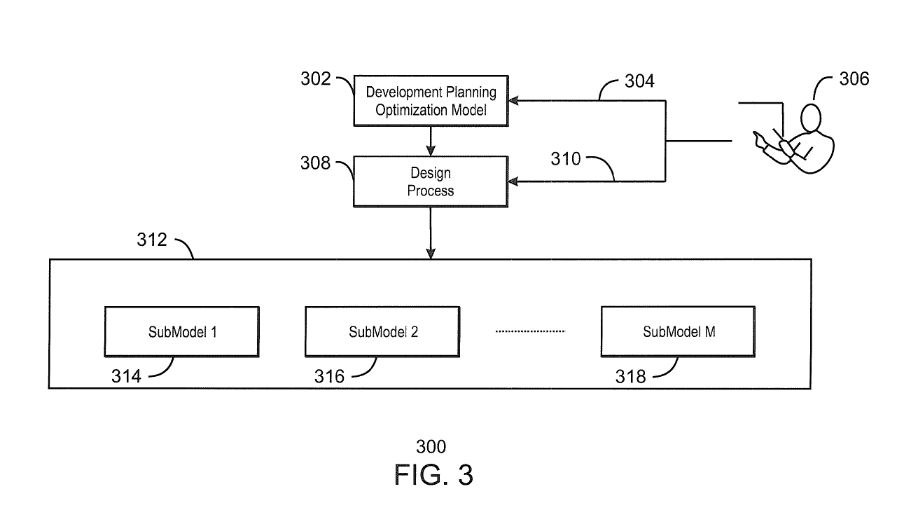

FIG. 3 is a block diagram of a process model 300 that may be used in an embodiment. In the process model 300, a development planning optimization model 302 may be given planning model requirements 304 by a development planner 306. The development planner 306 may also provide a lower level design process 308 with design process requirements 310. The design process includes the type and scope of decisions to be made for this particular optimization process. Such decisions may include, for example, the facility sizing, or timing, among others. From the design process 308, a set of sub-models 312 may be generated to model the process. The sub-models may include, for example, a high-fidelity or reference model 314 of a reservoir, a lower fidelity computer model 316, and any number of other models, including a tactical model 318, among others. The SML can provide a rigorous methodology for integrating high-fidelity reservoir models into a development planning optimization model that uses a low fidelity reservoir model with lower computational expense to estimate a modeling function and its derivative. This rigorous methodology allows convergence to a solution of the development planning optimization model that is validated by the higher fidelity computer model.

In contrast, more conventional derivative-based optimization methods employ an iterative procedure in which the simulation provides optimization model functions values and derivative information. In some embodiments, the iterative procedure uses this information to construct local approximations, for example, first or second-order Taylor series, to compute a better solution candidate. If evaluating the problem functions and derivatives involves a computationally expensive simulation, repeated evaluations may be prohibitively expensive. The algorithm subproblem includes solving the local approximation to get the new solution candidate.

The SML framework described herein replaces the local Taylor expansion model in the optimization subproblem with low-fidelity computer models that satisfy selected consistency conditions with respect to the high-fidelity computer model. The consistency conditions may include, for example, zero-order conditions in which the values from each model are matched at points or first-order conditions in which the slopes are matched at the points, among others. The responses of interest in the design optimization problem are the objective and constraints.

Generally, gains in computing time may be most significant when the trends in the low-fidelity computer model responses coincide with those of the high-fidelity computer model. The goal of the SML is to ensure that the low-fidelity optimization problem finds an optimum at or near the (mapped) location of the optimum of the high-fidelity optimization problem.

For the development planning of hydrocarbon assets, there are usually three main system components, production units, production systems, and markets. As noted above, a production unit is an underground storage unit containing certain amount of hydrocarbons, for example, a reservoir, a compartment, a region, or a field, among others. Production systems include the equipment and facilities used to produce hydrocarbons from the production units, including, for example, wells, pipeline systems, and surface facilities, such as FPSOs, compressors, and the like. Markets may include power plants, refineries, and LNG trains, among others.

To find the optimal development plan for a hydrocarbon asset, an optimization problem is constructed, which may include the components above. In addition the optimization problem may include an objective function capturing the system goals, including economic goals. Further, the optimal development plan may include a set of constraints needed to capture conditions that decisions specified by the optimization model need to respect. Such constraints may include logical constraints, such as scheduling and precedence, among others. The constraints may also include environmental constraints (such as flaring restrictions), operating constraints (facility capacity, oil production quota), safety conditions, and contractual constraints, among others. The following section describes the details of the proposed process and the models and optimization algorithms used in it.

### Optimization Process and Models for Reservoir Space

A high-fidelity or reference optimization model can be expressed as shown in Eqn. 2.

max f(u,y(u))

s.t. h(u,y(u))=0

g(u,y(u))≧0

uε[Lᵤ,Uᵤ Eqn. 2

In Eqn. 2, h(u,y(u))=0 and g(u,y(u))≧0 are mathematical representations of conditions or constraints that both the problem controls, u, and states, y, need to satisfy. The objective of the decision maker, for example, maximizing rate of return or net present value, is denoted by f. As noted, the constraints may include physical, financial, or environmental conditions. The controls u and state variables y can be linked via a reservoir simulation as shown in Eqn. 3.

S(u,y(u))=0 Eqn. 3

In the model presented in Eqns. 2 and 3, h and g represent explicit constraints on both controls and states while S(u,y(u)) represents the set of differential equations describing fluid flow in porous media. The differential equations are generally nonlinear.

A low-fidelity computer model may be represented as shown by the formulas in Eqn. 4.

max \tilde{f}(ũ,\tilde{y}(ũ))

s.t. \tilde{h}(ũ,\tilde{y}(ũ))=0

\tilde{g}(ũ,\tilde{y}(ũ))≧0ũε]L_{ũ},U_{ũ}] Eqn. 4

In Eqn. 4, all quantities with a tilde represent an object in the low-fidelity computer model space that corresponds to an object in the reference model. In the modeling framework, the function \tilde{f} can represent an economic measure for the hydrocarbon asset performance over a given planning period, usually years. The constraints, \tilde{h}( . . . )=0, and \tilde{g}( . . . )≧0 represent the physical assets, the reservoir performance and any other system constraints. The unknown control vector ũ includes continuous variables, such as injection and production rates, among others, and discrete variables, such as facility connections, and the like.

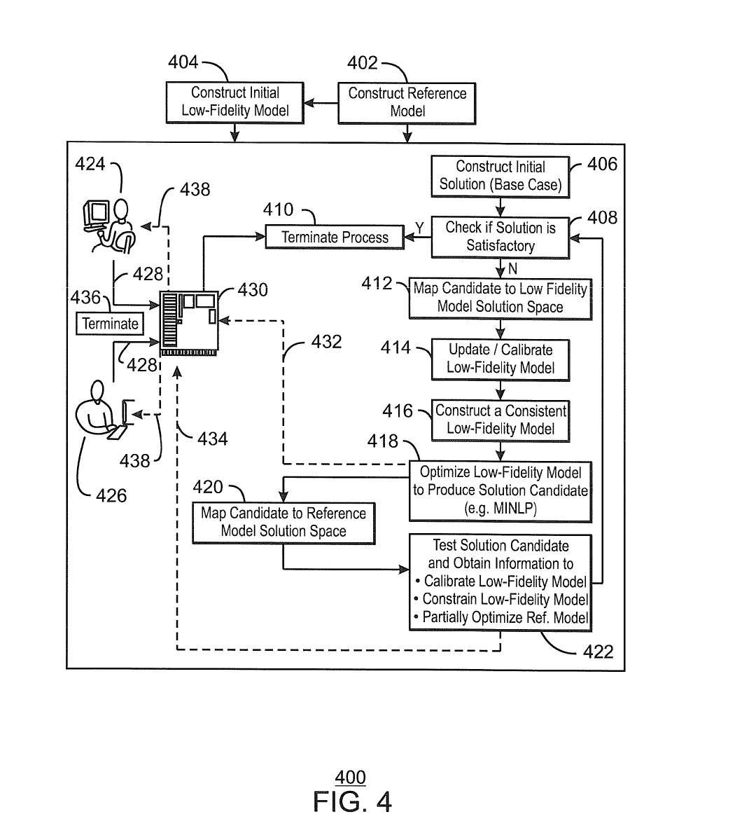

FIG. 4 is a block diagram illustrating a method 400 for implementing a surrogate management loop or SML, in accordance with an embodiment. The method 400 starts at block 402 with the construction of the high-fidelity or reference model. The high-fidelity computer model provides the most accurate results for the surrogate management loop, but at the highest computational cost. In development planning, a high-fidelity computer model may include economic relationships, a high-fidelity reservoir model, and a high-fidelity production system model, among others. The economic relationships may be based on the existing contractual agreements, estimates of prices and costs, and time value relationships, among others. As noted previously, a high-fidelity physical reservoir simulation model is a system of coupled nonlinear differential equations describing the flow of hydrocarbons in porous media. A high-fidelity production system model is a most detailed model of the physical equipment, including wells, pipelines, and facilities.

At block 404, a low-fidelity computer model may be constructed, for example, from the reference model. The low-fidelity computer model may use different surrogates for representing the development planning system components. Typically, a low-fidelity computer model for a reservoir simulation is a type-curve representing reservoir performance under given production system conditions. Such type-curves can include look-up tables linking a total or overall production performance measure, such as EUR, to fluid production properties, such as hydrocarbon production rates or rate ratios. The type curves can also be formulated in terms of cumulative water and/or gas production. The look-up tables can be mapped to a spline function or to a single function, for example, a polynomial function or an exponential function, to produce the reservoir low-fidelity computer model that is used for optimization. The low-fidelity computer model can be created as a mixed-integer non-linear programming (MINLP) model from the high-fidelity computer model. Alternatively, response surfaces can be constructed as functions of key parameters, for example, and used as low-fidelity models.

High-fidelity solutions may have many more operational details and time-steps, than low-fidelity solutions. For example, flow rates can be calculated with smaller time-steps (hours to days) in the high-fidelity computer model. By comparison, in the low-fidelity computer models, average flow-rates may be computed quarterly or annually. For the high-fidelity computer models, flow-rates may be assigned to individual wells. However, in low-fidelity computer models, rates may often be assigned to a coarser producing unit, such as a compartment, a region, a reservoir, or even a field. Some degree of consistency is needed to ensure proper behavior and convergence of the algorithms. Therefore, the mapping between variables is important to the success of the iterative process.

An initial solution can be generated at block 406 using the high-fidelity computer model. The main variables generated by a high-fidelity computer model can include injection rates per well and per computational time step, as well as downhole pressures per well and per computational time step. Further variables generated may include reservoir pressure at each computational cell, saturation at each computational cell, and material in moles, mass, surface barrels or other unit, at each computational cell. At block 408, the solution is checked to see if it is satisfactory. If so, the process may terminate at block 410.

If not, at block 412, the high-fidelity computer model variables may be mapped to the low-fidelity computer model variables by time- and spatial-aggregating, for example, of well rates, computational cells, and the like. For example, assuming that time-steps in the high-fidelity and low-fidelity computer models are Δtₕᵢ and Δtₗₒ, with N_{T}=Δtₗₒ/Δtₕᵢ and assuming that that we have k wells in a given compartment, then the mapping may be performed using Eqn. 5.

$${\sum }_{i = 1}^{k} {\sum }_{t = 1}^{{N}_{T}} {q}_{i} ( Δ {t}_{lo} ) = Q ( Δ {t}_{hi} ) \qquad Eqn . 5$$

A similar strategy can be used with an adaptive, or non-uniform, time stepping scheme. In an embodiment, upper and lower bounds may be assigned to low-fidelity compartment rates by a similar formula for the upper and lower bound of high-fidelity well rates. Actual high-fidelity well rates may be used for the same purpose.

At block 414, the low-fidelity computer model can be updated or calibrated by results from a high-fidelity simulation performed using variables such as facility sizing, order of compartment development, flow rates, and the like, determined by the low-fidelity optimization model, e.g., at the same point in space and time. Throughout, basic operational constraints for the high-fidelity reservoir simulation, for example, shut-in wells, may be applied. The type curve that depicts hydrocarbon production or recovery from each region or compartment may then be fitted to low-order functions, such as polynomial functions, exponential functions, or logarithmic functions, among others, and mapped back to the low-fidelity computer model to create the surrogate. At block 416, consistency conditions are imposed on the low-fidelity computer models to help ensure convergence of the solution candidate sequence generated by SML to a solution of the high-fidelity computer model

At block 418, the low-fidelity computer model may be optimized to produce a solution candidate. The algebraic nonlinear form of the low-fidelity computer model, type curves, results in an optimization model with both linear and nonlinear constraints for both continuous and discrete variables. The problem may be formulated as a mixed-integer nonlinear programming problem (MINLP). In embodiments, the MINLP problem may be solved by numerous techniques, including nonlinear branch and bound and outer approximations, among others.

At block 420, after generating solutions in a low-fidelity computer model, the low-fidelity variables may be mapped back to the high-fidelity variables. The mapping can be performed by a disaggregation of temporal variables, spatial variables, or both. For example, annual injection rates in a production unit, such as a compartment, a reservoir, or a field, can be disaggregated to the injection wells within the particular unit and then disaggregated temporally to the time-step of the reference optimization model.

At block 422, the candidate solution may be tested against the reference model. A number of activities may be performed at this block, including, for example, obtaining information used to calibrate the low-fidelity computer model at block 414, to constrain the low-fidelity computer model at block 416, or to partially optimize the reference model, among others. Process flow may then return to block 408 to begin the next iteration.

Users of the simulation, such as a development planner 424, or a reservoir engineer 426 may provide input 428 to a system 430 performing or overseeing the process 400 at any number of points. For example, intermediate results 432 may be provided to the system 430 for graphical display after the optimization of the low-fidelity computer model at block 418. Other results 434 may be provided after the solution candidate is tested at block 422. These intermediate results may be provided to the users 424 and 426 as shown by arrows 438. A user 424 or 426 may choose to send a command 436 to the system 430, for example, to terminate the process 400. Upon receiving the command 436, the system 430 may terminate the process 400 at block 410.

### Optimization Process and Models for Design Space

The techniques are not limited to high-fidelity computer models in which the reservoir simulations provides the complexity. In some embodiments, the design space may provide a significant source of complexity. The design space is the set of decisions to be made by the optimization. This could include the number of wells, the type of wells, the timing of facilities/compartments, or injection/production rates for a given compartment. In these embodiments, the decision space can be decomposed into several subspaces and the development planning design process can be configured in such a way that each set of decisions corresponding to a subspace is evaluated iteratively via a set of multi-level optimization models.

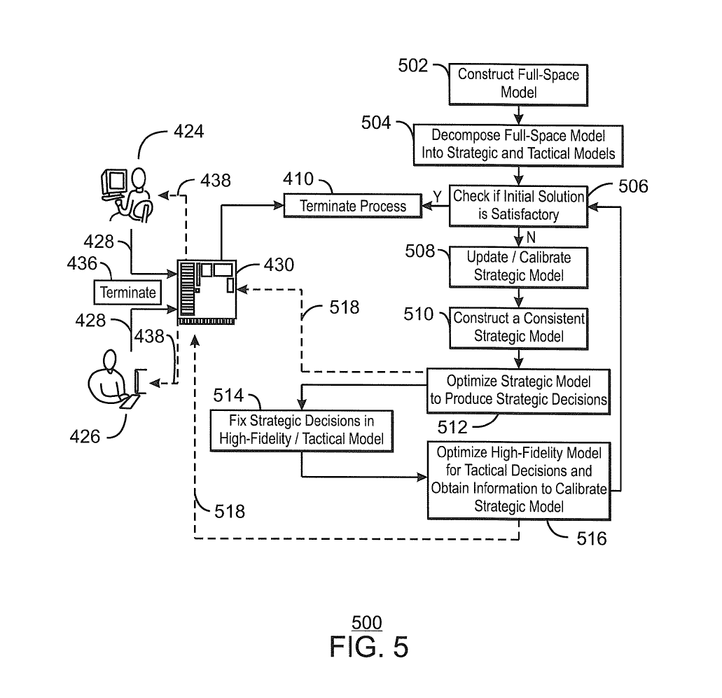

FIG. 5 is a block diagram illustrating a method 500 for implementing a surrogate management loop in which the design space provides the complexity, in accordance with an embodiment. In the method 500, like numbered blocks are as described with respect to FIG. 4. For simplification, the discussion is restricted to a bi-level process, although any number of nested levels may be used. The method 500 begins at block 502 with the construction of a full space model.

At block 504, the full space model is decomposed into two parts. A first part includes strategic decisions, such as FPSO count, and facility sizes/types, among others. A second part includes tactical decisions such as injection rates, flow rates, and the like. Some decisions may belong to either part, for example, well types, among others. Embodiments allow a user the flexibility to choose how to decompose the space.

As an example, it may be assumed that the design variables u are decomposed into strategic variables, v, and tactical variables, w, i.e., u=(v,w). Thus, the optimal development planning problem can be written as shown in Eqn. 6.

max f((v,w),y(v,w))

s.t. h((v,w),y(v,w))=0

g((v,w),y(v,w))≧0

vε[Lᵥ;Uᵥ]

wε[L_{w};U_{w}]Eqn. 6

Different decisions may require different objective functions. For example, strategic decisions may require the use of complex economics, including the fiscal terms, while tactical decisions, such as rates, may be adequately determined using considerations without fiscal terms. For purposes of this explanation, fiscal term objectives may be denoted by f₁, while objectives without fiscal terms may be denoted as f₂. To facilitate notation, the constraints in the above problem can be ignored, although the constraints can be incorporated in the formulation and algorithmic framework. The problem shown in Eqn. 6 can then be formulated as shown in Eqn. 7.

max f₂(w,y₂(w))

s.t. wεargmaxf₁(v,y₁(v)) Eqn. 7

In Eqn. 7, the MINLP is solved for the strategic decisions, v. Those decisions can then be fixed in the high-fidelity computer model and then a second optimization problem can be solved for the tactical decisions, w. At block 506, the solution is checked to determine if the goals have been reached. If so, process flow terminates at block 410. If not, process flow proceeds to block 508.

At block 508, the strategic model is updated in a similar process to block 414 of FIG. 4. At block 510, a consistent strategic model is constructed, in a manner similar to the construction of the consistent low-fidelity computer model in block 416. At block 512, the strategic model is optimized to produce strategic decisions. At block 514, the strategic decisions are fixed, for example, a well type may be set, or a well location may be fixed, in the high-fidelity or tactical model. At block 516, the high-fidelity or reference model can be optimized for tactical decisions, providing information to calibrate strategic decisions. The optimization of the reference model at block 516 may be performed using a hierarchical series of models, for example, by nesting the method 400 in block 516 to solve the model. Process flow may then return to block 506 to start the next iteration.

As for the method 400 of FIG. 4, intermediate results 518 may be provided to the system 430 running or overseeing the method 500 for graphical presentation to users 424 and 426 as shown by arrows 438. The users 424 or 426 may then issue a command 436, for example, to terminate the method 500 at block 410.

It can be observed that the tactical variables are also part of the strategic model formulations. However, the role they play in the strategic planning problem may be secondary, though still important, in the sense that they are used to obtain feasible solutions. The optimal value they assume from the strategic model can be used as a starting point for the optimization of the tactical model. Further, it is not essential to solve either problem (strategic or tactical) exactly. The iterative process only needs to guarantee progress at each pass. Further details for constructing a consistent low-fidelity computer model, solving the low-fidelity optimization model, and assessing the solution candidate are discussed in the sections that follow.

### Constructing a Consistent Low-Fidelity Computer Model

Consistency conditions may help to locally match the reference and the low-fidelity computer models up to a certain derivative order. For example, consistency conditions may include the zero-order and first-order conditions shown in the formulas of Eqn. 8, among others. As used herein, a first-order condition can be used to force the value from the low-fidelity computer model to match a value from the high-fidelity computer model at a particular point in the solution space. Similarly, a first-order condition can be used to force the result from each model to have the same slope at a particular point in the solution space.

\tilde{f}(ũ_{c})=f(u_{c})

∇_{ũ}\tilde{f}(ũ_{c})

\tilde{h}(ũ_{c})=h(u_{c})

∇_{ũ}\tilde{h}(ũ_{c})=∇h(u_{c})

\tilde{g}(ũ_{c})=g(u_{c})

∇_{ũ}\tilde{g}(ũ_{c})=∇g(u_{c}) Eqn. 8

In the formulas shown in Eqn. 8, u_{c} represents the current solution candidate. It can be noted that these formulas are more specific versions of the formulas shown in Eqn. 4. In an embodiment, an approach that may be used to ensure consistency in the creation of the low-fidelity computer model is to construct a look-up table representing the type-curve and use a constrained least squares approach to fit an algebraic function (e.g., polynomial) to this data with the constraints that it matches zero- and first-order information from the high-fidelity computer model.

However, if the consistency conditions are not satisfied by an existing low-fidelity computer model, as is the case in many type-curves, several techniques exist to correct the low-fidelity computer model to satisfy the consistency conditions. For example, a multiplicative β-correction, may be performed. To implement this correction, set

$$β ( u ) = \frac{f ( u )}{\tilde{f} ( \tilde{u} )} .$$

then at a given iteration, xₖ, the formula in Eqn. 9 may be constructed.

βₖ(u)=β(uₖ)+∇β(uₖ)^{T}(u−uₖ) Eqn. 9

The “corrected” low-fidelity computer model can then be constructed as shown in Eqn. 10.

\tilde{f}ₖ(u)=βₖ(u)\tilde{f}(ũ) Eqn. 10

In another embodiment, an additive correction may be performed using the formula shown in Eqn. 11.

\tilde{f}ₖ(u)=\tilde{f}(ũ)+[f(uₖ)−\tilde{f}(ũₖ)]+[∇f(uₖ)−∇\tilde{f}(ũₖ)]^{T}(u−uₖ) Eqn. 11

### Solving the Low-Fidelity Optimization Model

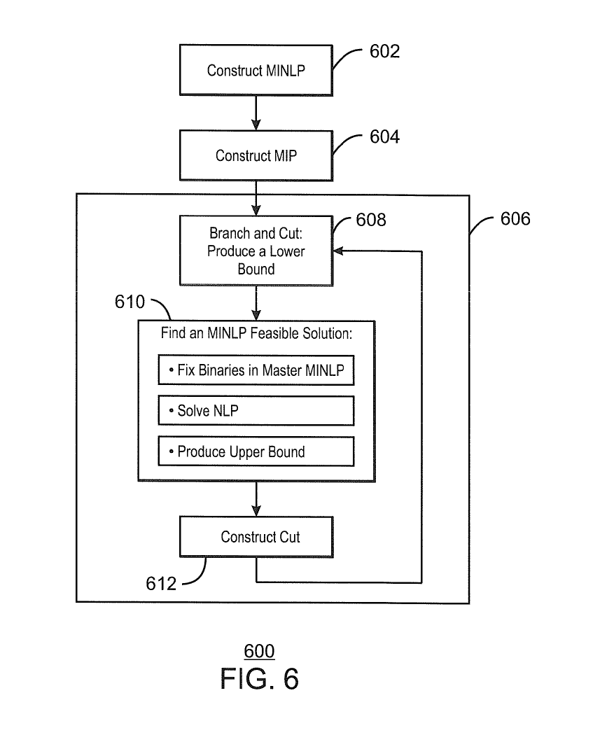

FIG. 6 is a process flow diagram of a method 600 for solving a mixed integer nonlinear programming (MINLP) model in accordance with an embodiment. This method 600 may be one of a number of methods that may be used in block 418 of FIG. 4 or block 512 of FIG. 5 to solve a low-fidelity computer model. In the framework of FIG. 4 and FIG. 5, a MINLP model that represents the low-fidelity computer model may be solved by using a modified linear programming/nonlinear programming (LP/NLP) branch and bound method. The method 600 starts at block 602 with the construction of the MINLP model. This may be done by constructing an objective function that represents the economic target of the decision-maker, a set of constraints representing the physical asset, such as the reservoir and wells, and logical constraints representing sequencing and timing conditions. Constructing reservoir constraints may be performed in part, for example, by constructing a type-curve from points obtained from a reference model, as described above. At block 604, a mixed integer programming (MIP) model is constructed from the MINLP model. This can be done, for example, by linearizing all nonlinear constraints and the objective function. Block 606 represents the iterative process of solving the MIP model. There may be different ways to construct the MIP model such as reformulation, piece-wise linear or piece-wise constant approximation. Each method leads to a different relaxation or convexification. However, approximations that do not create a proper convex feasible solution space of the original solution space usually lead to heuristic solutions that do not guarantee global optimality. At block 608, a branch and cut procedure is used to produce a lower bound. Small to medium size low-fidelity models may be optimized using a branch and cut procedure in a reasonable time frame. When the model gets large, conventional methods may not be efficient for optimizing such systems. A way to tackle such large scale instances is to use a decomposition method such as Benders' or Dantzig-Wolfe decomposition. Benders' decomposition adds new constraints (rows) to the model and therefore it is called “row generation”. Similarly, Dantzig-Wolfe decomposition adds new variables (columns) to the model and therefore it is called “column generation”. In both decomposition methods, the main idea is to start with a model that is simpler than the original and add rows or columns iteratively within the algorithm. Specifically, in column generation, the optimization starts with a small part of the original model. After solving that part, the optimal solution and the dual information are used for deciding which of the variables (columns) should be included into the model. This process is repeated until a satisfactory solution is achieved for the entire model. For the oilfield model, Dantzig-Wolfe type of decomposition algorithm is useful due to the high number of binary variables required to have a tight formulation for modeling complex fiscal terms.

At block 610, an MINLP feasible solution may be identified. This may include fixing binary or integer quantities in the master MINLP model, solving a nonlinear programming (NLP), and producing an upper bound. At block 612, a cut, which may be an equation that eliminates a certain solution space, may be constructed. After the cut is constructed, process flow returns to block 608 to continue with the next iteration. This process is continued until one of the system users terminate the process, the time allocated is reached, or a stopping criteria test is satisfied at block 408. The method 500 is further explained with respect to FIG. 6.

Another way of formulating the low-fidelity computer model could also be a mixed-integer nonlinear program (MINLP) with complementarity constraints. Complementarities are useful in optimization since they can be used to model certain discontinuities without using binary variables. B. T. Baumrucker, J. G. Renfro and L. T. Biegler, “MPEC problem formulations and solution strategies with chemical engineering applications”, Computers and Chemical Engineering, 32 (2008) pp. 2903-2913, is a reference that discusses some of the basics of complementarity formulations. Complementarity constraints arise in the low-fidelity computer model through two means: representation of discrete or disjunctive relations, and reformulating mild forms of discontinuities (e.g. min, max, abs, sign, etc.) in governing equations in the fiscal model. Using MINLPs with complementarity constraints is a new technology, see A. Guerra, A. M. Newman, and S. Leyffer, “Concrete Structure Design using Mixed-Integer Nonlinear Programming with Complementarity Constraints”, SIAM J. Optimization, 21 (2011), pp. 833-863. This technology has not been previously applied to oilfield development planning. Complementarity has an advantage of converting discrete decisions into continuous representations. This makes the search process faster.

Once the low-fidelity model is reformulated using complementarity constraints, it can then be solved by:
Standard techniques for MINLP (nonlinear branch-and-bound, outer approximation, extended cutting plane, etc.);
Creating a linear relaxation model (which may be a mixed integer linear program (MILP) of the MINLP model, optimizing the linear relaxation model and tightening linear relaxations iteratively, and generating feasible solutions for the MINLP model from the feasible solutions found for the linear relaxation model, where the relaxation model includes relaxations of nonlinearities associated with any complementarity constraint;
Creating a linear relaxation model (which may be a mixed integer linear program (MILP) of the MINLP model, optimizing the linear relaxation model and tightening linear relaxations iteratively, and generating feasible solutions for the MINLP model from the feasible solutions found for the linear relaxation model, where the relaxed model may or may not contain approximations of nonlinearities associated with any complementarity constraint.

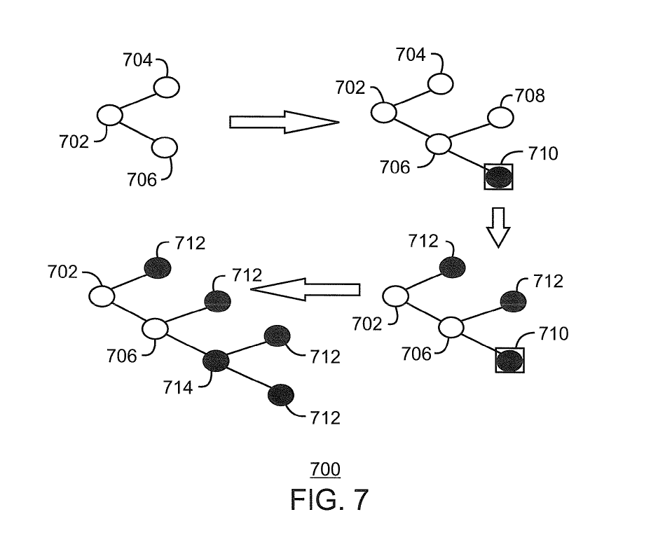

FIG. 7 is a drawing of a procedure 700 that may be used to create a branch in the method 600 used in FIG. 6, in accordance with an embodiment. The master MIP model 702 has a number of branches, e.g., branches 704 and 706. Each branch 704 and 706 may represent a decision point, and, thus a scenario, in the planning process. For example, branch 704 may represent the use of three FPSO to access a subsea field, while 706 may represent the use of two FPSO to access the subsea field. Each branch 704 or 706 may or may not represent a feasible solution, depending on the conditions. Further decisions create more branches, such as branches 708 and 710. An integer “linear” feasible point may be identified in the branching tree, such as branch 710. At that point, the nonlinear programming problem is solved and the feasibility of the solution is determined. Feasible problem functions may then be linearized around the new point, e.g., branch 710. The linearizations may be added as new constraints, e.g., branch 712 to each of the tree nodes. Further, the linearized constraints may be added to other nodes 714 are they are created. Nodes that are not feasible, such as branch 704, may be removed or pruned from the tree.

The method described with respect to FIGS. 6 and 7 is useful for a convex MINLP. However, models may often have a nonconvex MINLP, for example, because of nonlinear equality constraints representing reservoir responses. Further, the reference model, which ultimately assesses the quality of the solution, may not be convex. Effective methods for nonconvex MINLP optimization aim at finding a tight relaxation or a good lower bound on the optimal solution value. In the MILP case, a lower bound can be found by solving the LP relaxation obtained by relaxing integrality on the variables. As used herein, “relaxing integrality” indicates that variables that are integral may be allowed to take intermediate values during the optimization algorithm. For example, a solution may use a value of 3.3 FPSO platforms rather than 3 or 4 FPSO platforms.

In the MINLP case, relaxing integrality yields a convex nonlinear problem and hence a lower bound. In the general case, finding a relaxation and a lower bound on the global optimum for the original MINLP can be problematic, since relaxing integrality may provide a nonconvex NLP. When the relaxation does not obtain a strong lower bound, an approach to strengthening the relaxation is to use logical disjunctions (“or's”) that are satisfied by all solutions of the MINLP problem.

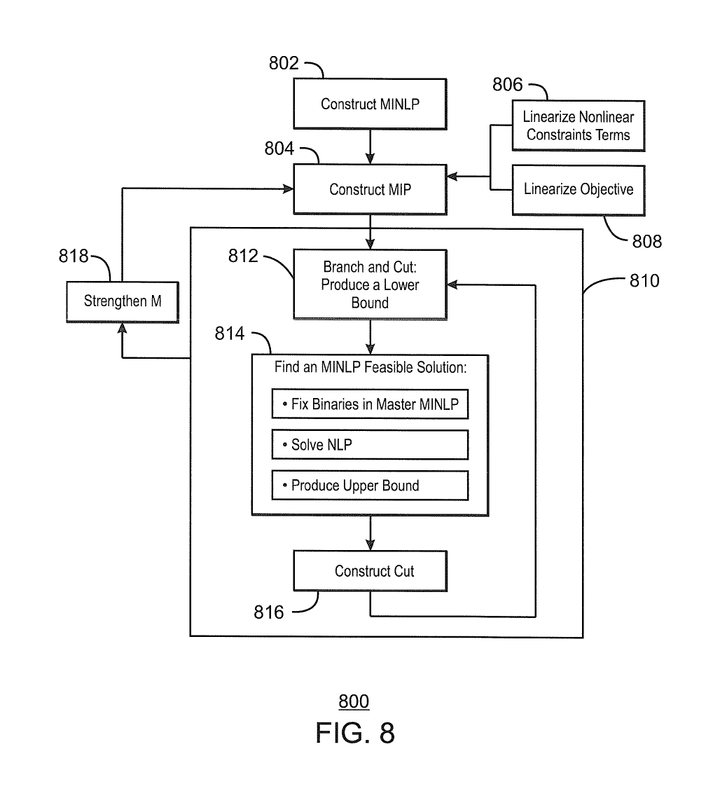

FIG. 8 is a block diagram of a method 800 that may be used in embodiments. The method 800 starts at block 802 with the construction of the MINLP model. As for the method 600 discussed with respect to FIG. 6, the MINLP model may be optimized using a sequence of mixed-integer linear programming (MILP) models.

At block 804, an MIP is constructed from the MINLP model. As shown at block 806, the nonlinear constraint terms may be linearized. For example, bilinear and nonlinear terms can be linearized using linear envelopes, i.e. linear functions that underestimate and overestimate a given nonlinear term in such a way that the feasible space of the resulting optimization problem is a larger than, i.e., a relaxation of, the original feasible space. One way of performing this function is the use of McCormick under-estimators, known as McCormick envelopes. McCormick envelopes for product terms produce tight linear constraints that cover at least the feasible space covered by the product term. It may happen, however, that the feasible space of the linear problem is too large to produce reasonable solutions. In this case there is a need to tighten the envelope, for example, by making the new feasible space smaller, while still holding the original nonlinear feasible space.

As indicated at block 808, the objectives may be linearized, for example, by using disjunction logic to model tiered economical structures, or tranches, in the objective function. Further, an embodiment may allow interrogation of the MINLP feasible solution, whenever one is found, wherein the feasible solution is provided to the high-fidelity or reference optimization problem. This candidate can be used for testing progress or providing more information, such as cuts, that can be used in the MINLP problem.

The iterative problem to solve the MINLP is in block 810 and is similar to the procedure used in block 606 of FIG. 6. At block 812, a generic branch and cut procedure can be used to produce a lower bound. At block 814, an MINLP feasible solution may be identified. This may include fixing binary or integer quantities in the master MINLP model, solving a nonlinear programming (NLP), and producing an upper bound. However, it can be noted that fixing all binaries may provide infeasible solutions. In such a case, as discussed, only a subset of binary variables may be fixed and an outer approximation algorithm may be used to generate feasible solutions, or fiscal models.

At block 816, the cut may be constructed. After the cut is constructed, process flow returns to block 812 to continue with the next iteration and it terminates when the two or more consecutive solutions are found to be within a specified tolerance, typically a few percent, and process flow proceeds to block 818.

Certain physical, user, or contractual constraints can be modeled mathematically by logical relations or nonconvex functions. Such relations can be difficult to work with and hence they are often replaced by other easier-to-use mathematical relations called the big-M constraints. As used herein, big-M refers to a certain adjustable parameter in the new formulated constraints. The M parameter has to be large to cover the original feasible but small enough to eliminate numerical problems. The Big-M constraints may create weak linear relaxations, which may extend the time to optimize the problem in the branch-and-cut procedure. In order to speed up the branch-and-cut procedure, at block 818, Big-M parameters can be assigned smaller values that are valid in practice, which can be termed “strengthening M.” Since the solution time is much smaller with these new values of the parameters, the MIP model can be solved iteratively and the values of the Big-M parameters can be updated at each of the iterations. From block 818, flow proceeds to block 804 for the next iteration, and may continue until two or more consecutive solutions are found to be within a specified tolerance

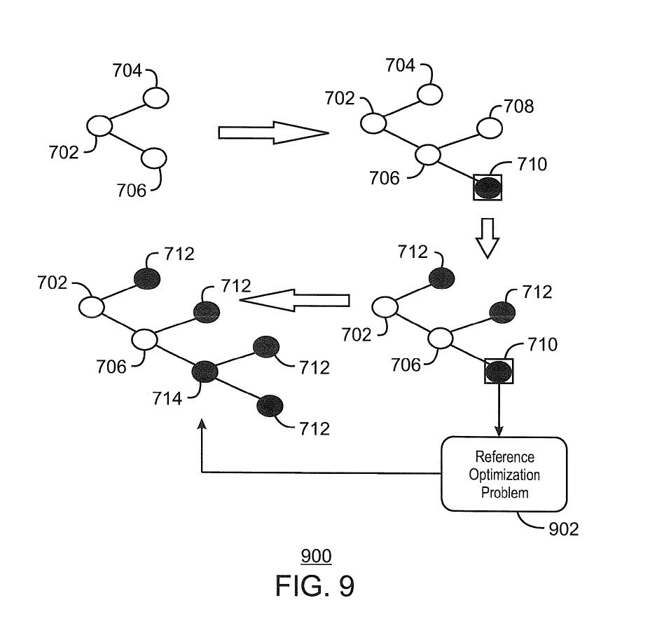

FIG. 9 is a drawing of a procedure 900 that may be used to create a branch in the method 800 discussed with respect to FIG. 8, in accordance with an embodiment. The branch procedure is similar to that discussed with respect to FIG. 7, and like numbers are as previously discussed. At block 902, the procedure in FIG. 9 uses a reference optimization problem to test the quality of the solution and potentially gather information to improve the low fidelity computer model and determine whether low-fidelity solution candidate provides good solution candidate for high fidelity computer model.

### Assessing High-Fidelity Candidates

Once a new high-fidelity candidate has been obtained, for example, by mapping a low-fidelity solution back into the high-fidelity space, the algorithm framework proceeds to test it for progress against the previous solution of the reference model. In an embodiment a 2-step hierarchical test may be used. First, in the higher-level space, the discrete variables are adjusted to be within some neighborhood of the discrete space. For example, if a given reservoir is scheduled to come on production at year 10, the procedure will test the quality of the solutions for which the reservoir will come on production at years 9 and 11. Then, for each assignment of discrete variables in step 1, the continuous variables may be tested in the following procedure. The quantity shown in Eqn. 12 can be computed.

$$γ ( {u}^{c} ) = \frac{f ( {u}_{+}^{c} ) - f ( {u}^{c} )}{\tilde{f} ( {\hat{u}}_{+}^{c} ) - \tilde{f} ( {\hat{u}}^{c} )} \qquad Eqn . 12$$

The numerator in Eqn. 12 measures the actual increase in the high-fidelity objective function, while the denominator is a measure of the predicted increase from the low-fidelity objective function. To identify an appropriate solution candidate, certain conditions may be imposed to ensure that this factor (γ) is well-behaved. For example, the new candidate u₊^{c} may be accepted if the condition in Eqn. 13 is true.

f(u₊^{c})>f(u^{c}) Eqn. 13

If the condition in Eqn. 13 is not true, the candidate solution can be rejected. In either case, the factor γ computed in Eqn. 12 can be used to update bounds on the continuous variables, in a trust-region fashion, that are enforced in the low-fidelity optimization problem (MINLP). For example, if γ is too small, the bounds can be reduced. If it is relatively large, the bounds can be left unchanged. If γ is very large, the bounds can be enlarged.

### Partially Optimizing the Reference Model

In some embodiments, the high-fidelity or reference model may be partially optimized. This can be performed by constructing a quadratic programming model of the reference optimization model. The quadratic model requires first and second order derivatives of the objective function and constraints. If second order derivatives are expensive to compute, an approximation technique, such as the Broyden-Fletcher-Goldfarb-(BFGS) method, may be used. The BFGS method is a hill-climbing optimization technique that seeks a stationary point of a function that is twice continuously differentiable. For such problems, a condition for optimality is that the gradient be zero. The BFGS update is a technique to approximate the second order derivative matrix using the first order information.

From the two steps above, new bounds on the reference model variables can be computed. A new low-fidelity computer model may then be computed using the new production system conditions set by the discrete variables. The sensitivities of the objective function can be computed by calculating the adjoint equations to find the sensitivities of reservoir simulation state variables.

### General Method

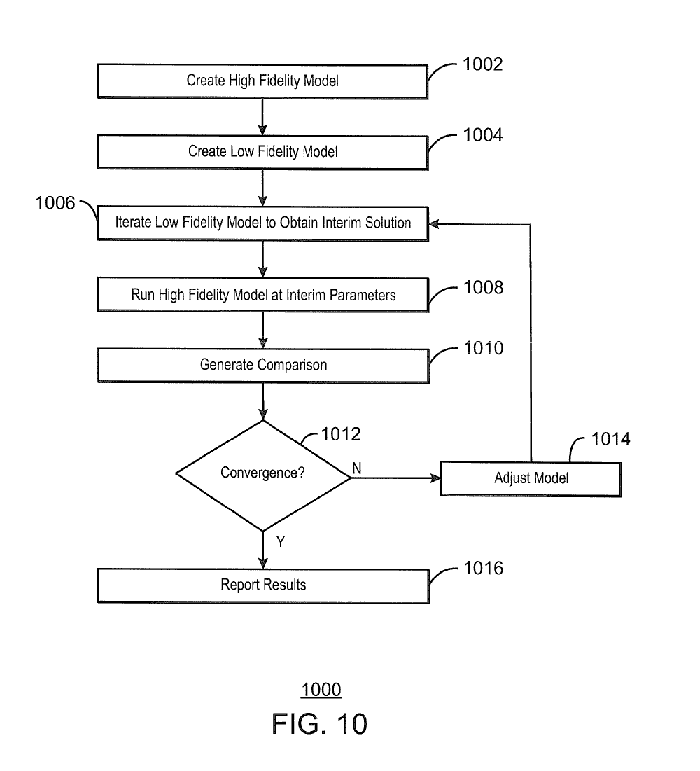

FIG. 10 is a block diagram of a general method 1000 encompassing the methods discussed with respect to FIGS. 4 and 5, in accordance with various embodiments. The method 1000 begins at block 1002 with the creation of a high-fidelity or reference model. At block 1004, one or more low-fidelity computer models are created from the reference model. The high-fidelity computer model and the low-fidelity computer models may include reservoir models, strategic models, tactical models, economic models, or any combination thereof. At block 1006, the low-fidelity computer models are iterated to obtain an interim solution, e.g., a solution that converges at the particular parameters. It will be understood that this may not be the final solution, since, after calibration, the low-fidelity computer models may not be at a convergence point. At block 1008, the reference model may be run at the parameters of the interim solution. At block 1010, the solution obtained from the reference model and the interim solution are compared. If the interim solution has not converged, at block 1012 process flow resumes at block 1014. At block 1014, the comparison may be used to adjust the low-fidelity computer models, the high-fidelity computer model, or both. Process flow can then return to block 1006 for another iteration. If convergence is detected at block 1012, e.g., the solution has not changed by more than a pre-determined amount from the last iteration, process flow may proceed to block 1016, at which the results are reported and the method 1000 terminates.

### Exemplary Cluster Computing System

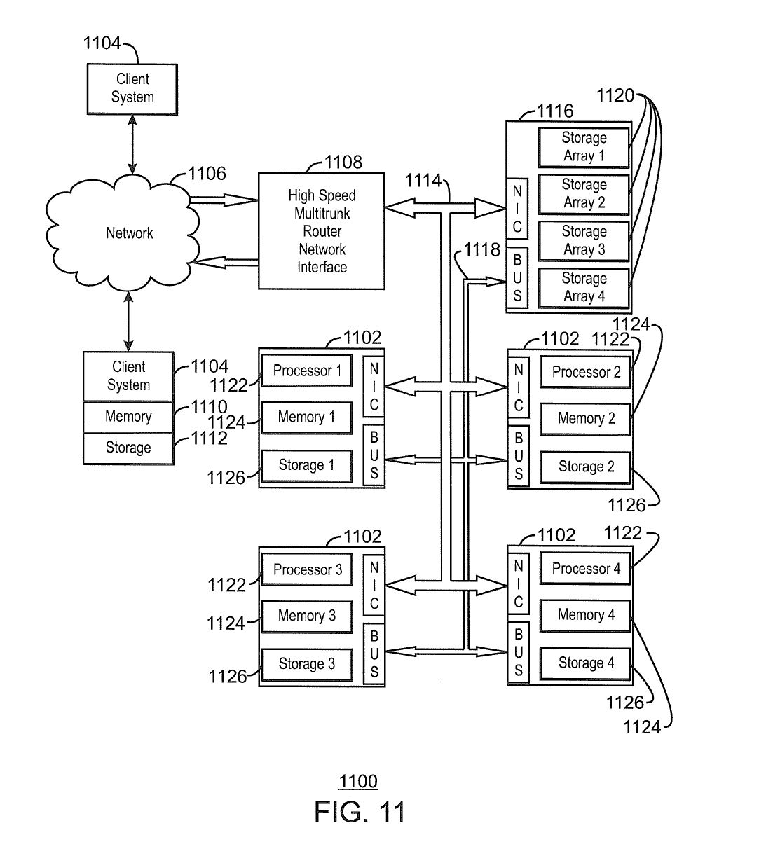

FIG. 11 is a block diagram of an exemplary cluster computing system 1100 that may be used in exemplary embodiments of the present techniques. The cluster computing system 1100 illustrated has four computing units 1102, each of which may perform calculations for part of the simulation model. However, the present techniques are not limited to this configuration, as any number of computing configurations may be selected. For example, a small simulation model may be run on a single computing unit 1102, such as an individual workstation, while a large simulation model may be run on a cluster computing system 1100 having 10, 100, 1000, or even more computing units 1102.

The cluster computing system 1100 may be accessed from one or more client systems 1104 over a network 1106, for example, through a high speed network interface 1108. Each of the client systems 1104 may have non-transitory, computer-readable memory 1110 for the storage of operating code and programs, including random access memory (RAM) and read only memory (ROM). The operating code and programs may include the code used to implement all or portions of the methods discussed with respect to FIGS. 4-10. The client systems 1104 can also have other non-transitory, computer-readable media, such as storage systems 1112. The storage systems 1112 may include one or more hard drives, one or more optical drives, one or more flash drives, any combinations of these units, or any other suitable storage device. The storage systems 1112 may be used for the storage of code, models, data, and other information used for implementing the methods described herein.

The high speed network interface 1108 may be coupled to one or more busses in the cluster computing system 1100, such as a communications bus 1114. The communication bus 1114 may be used to communicate instructions and data from the high speed network interface 1108 to a cluster storage system 1116 and to each of the computing units 1102 in the cluster computing system 1100. The communications bus 1114 may also be used for communications among computing units 1102 and the storage array 1116. In addition to the communications bus 1114, a high speed bus 1118 can be present to increase the communications rate among the computing units 1102 and the cluster storage 1116.

The cluster storage system 1116 can have one or more non-transitory, computer-readable media devices, such as storage arrays 1120. The storage arrays 1120 may include any combinations of hard drives, optical drives, flash drives, holographic storage arrays, or any other suitable devices. The storage arrays 1120 may store data, visual representations, results, code, or other information, for example, concerning the implementation of and results from the methods of FIGS. 4-10.

Each of the computing units 1102 can have a processor 1122 and associated local tangible, computer readable media, such as memory 1124 and storage 1126. The processor 1122 may be a single core processor, a multi-core processor, or a cluster of processors. The memory 1124 may include ROM and/or RAM used to store code, for example, used to direct the processor 1122 to implement the methods illustrated in FIGS. 4-10. The storage 1126 may include one or more hard drives, one or more optical drives, one or more flash drives, or any combinations thereof. The storage 1126 may be used to provide storage for intermediate results, data, images, or code associated with operations, including code used to implement the methods of FIGS. 4-10.

The present techniques are not limited to the architecture of the cluster computer system 1100 illustrated in FIG. 11. For example, any suitable processor-based device may be utilized for implementing all or a portion of embodiments of the present techniques, including without limitation personal computers, laptop computers, computer workstations, GPUs, mobile devices, and multi-processor servers or workstations with (or without) shared memory. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

While the present techniques may be susceptible to various modifications and alternative forms, the embodiments discussed above have been shown only by way of example. However, it should again be understood that the present techniques are not intended to be limited to the particular embodiments disclosed herein. Indeed, the present techniques include all alternatives, modifications, and equivalents falling within the true spirit and scope of the appended claims.

What is claimed is:

1. A method for generating a development plan for a hydrocarbon asset, comprising:
creating a high-fidelity computer model of a hydrocarbon asset;
creating a low-fidelity computer model of the hydrocarbon asset;
iterating on the low-fidelity computer model to an interim solution;
generating a comparison of the interim solution to a solution obtained from a simulation of the high-fidelity computer model at the variables of the interim solution;
calibrating the low-fidelity computer model, based, at least in part, on the comparison; and
generating the development plan for the hydrocarbon asset based, at least in part, on a result from the calibrated low-fidelity computer model;
wherein the low-fidelity computer model is a mixed-integer nonlinear programming problem with complementarity.

2. The method of claim 1, comprising adjusting the high-fidelity computer model based, at least in part, on the comparison.

3. The method of claim 1, wherein creating the high-fidelity computer model comprises creating a reservoir simulation for a hydrocarbon bearing compartment.

4. The method of claim 1, wherein calibrating the low-fidelity computer model comprises adjusting the low-fidelity computer model to provide a matching result to the high-fidelity computer model at a point in a low-fidelity solution space that corresponds to a point in a high-fidelity solution space.

5. The method of claim 1, wherein calibrating the low-fidelity computer model comprises adjusting the low-fidelity computer model to provide a matching first-derivative to the high-fidelity computer model at a point in a low-fidelity solution space that corresponds to a point in a high-fidelity solution space.

6. The method of claim 1, comprising mapping the interim solution to the high-fidelity space.

7. The method of claim 1, comprising constraining the low-fidelity computer model, based, at least in part, on the comparison.

8. The method of claim 1, comprising partially optimizing the high-fidelity computer model.

9. The method of claim 1, comprising creating the low-fidelity computer model by using less degrees of freedom than the high-fidelity computer model.

10. The method of claim 1, comprising generating a graphical representation of the development plan during or after an optimization process.

11. The method of claim 1, further comprising solving the low-fidelity computer model by
creating a linear relaxation model of the low-fidelity computer model,
optimizing the linear relaxation model and tightening linear relaxations iteratively, and
generating feasible solutions for the low-fidelity model from feasible solutions found for the linear relaxation model.

12. The method of claim 11, wherein the linear relaxation model comprises a mixed integer linear program (MILP).

13. The method of claim 1, comprising creating a mixed-integer nonlinear programming problem (MINLP) model as the low-fidelity computer model.

14. The method of claim 13, comprising solving the MINLP model using a branch-and-bound technique.

15. The method of claim 13, comprising:
creating a linear relaxation model of the MINLP model;
optimizing the linear relaxation model and tightening linear relaxations iteratively; and
generating feasible solutions for the MINLP model from the feasible solutions found for the linear relaxation model.

16. The method of claim 17, wherein the linear relaxation model comprises a mixed integer linear program (MILP).

17. A system for generating a development plan for a hydrocarbon asset, comprising:
a processor; and
a non-transitory, computer readable medium, comprising:
a high-fidelity computer model of a hydrocarbon asset; and
code configured to direct the processor to
create a low-fidelity computer model of the hydrocarbon asset from the high-fidelity computer model, the low-fidelity computer model being a mixed-integer nonlinear programming problem with complementarity;
iterate the low-fidelity computer model to an interim solution;
compare the interim solution to a solution obtained from a run of the high-fidelity computer model at the parameters of the interim solution;
calibrate the low-fidelity computer model, based, at least in part, on the comparison; and
provide a development plan based, at least in part, on a calibrated low-fidelity computer model.

18. The system of claim 17, comprising code configured to direct the processor to adjust the high-fidelity computer model based, at least in part, on a result from the calibrated low-fidelity computer model.

19. The system of claim 17, wherein the system is part of a cluster computing system.

20. The system of claim 17, comprising code configured to direct the processor to create a strategic model, a tactical model, or any combination thereof.

21. The system of claim 17, wherein one or more of the low-fidelity computer model and the high-fidelity computer model comprises a strategic model.

22. The system of claim 17, wherein one or more of the low-fidelity computer model and the high-fidelity computer model, comprises a tactical model.

23. The system of claim 17, wherein one or more of the low-fidelity computer model and the high-fidelity computer model comprises an economic model of the hydrocarbon asset.

24. The system of claim 17, wherein the development plan comprises a tactical decision that is one or more of an injection flow rate, a production rate, and a timing for a compartment.

25. The system of claim 17, wherein the development plan comprises a strategic decision that is one or more of well location, a number of production platforms, and a type of a production platform.

26. The system of claim 17, wherein the low fidelity computer model is generated from the high fidelity computer model using an optimization framework to ensure consistency.

27. The system of claim 17, further comprising code for solving the low-fidelity computer model by
creating a linear relaxation model of the low-fidelity computer model,
optimizing the linear relaxation model and tightening linear relaxations iteratively, and
generating feasible solutions for the low-fidelity model from feasible solutions found for the linear relaxation model.

28. The method of claim 17, wherein the linear relaxation model comprises a mixed integer linear program (MILP).

29. A non-transitory computer readable medium comprising code configured to direct a processor to:
iterate a low-fidelity computer model to an interim solution, the low-fidelity computer model being a mixed-integer nonlinear programming problem with complementarity;
compare the interim solution to a solution obtained from a run of a high-fidelity computer model at the parameters of the interim solution;
calibrate the low-fidelity computer model, based, at least in part, on the comparison; and
generate a development plan for a hydrocarbon asset based, at least in part, on a result from a calibrated low-fidelity computer model.
